(19) United States
(12) Patent Application Publication
(10) Pub. No.: US 2025/0265948 A1
(43) Pub. Date: Aug. 21, 2025

(54) LINERLESS TIRE LABEL AND ROLLS OF LINERLESS TIRE LABELS

(71) Applicant: Iconex LLC, Duluth, GA (US)

(72) Inventors: Suresh Narayanan, Whittlesey (GB); Andrew Simon Jakes, Whittlesey (GB)

(21) Appl. No.: 18/582,832

(22) Filed: Feb. 21, 2024

(51) Int. Cl. G09F 3/10; G09F 3/00; G09F 3/02

(52) U.S. Cl. CPC G09F 3/10; G09F 3/0297; G09F 2003/0229; G09F 2003/0247

(57) ABSTRACT

A linerless tire label and roll of linerless tire labels are provided. Each linerless tire label includes an adhesive patch disposed on a backside of a single label substrate. Gaps of adhesive-free areas surround the adhesive patch, and the gaps are adjacent to the sides of the backside label substrate. A front side of the label substrate has a print coating and a release coating disposed over the print coating. Each label on the roll is also separated by an oversized sense mark the extends the width of the backside of the label substrate. Each sense mark is also adjacent to a pair of adhesive-free gaps of the backside.

### BACKGROUND

Tire labels or stickers are affixed to tires by manufacturers or retailers for a various purposes, such as providing important safety information, compliance with regulations, or branding. The specific information required on removable tire labels can vary depending on the jurisdiction and the intended purposes of the label. The information can include, by way of example only, tire identification numbers (TINs), tire sizes, tire type, load index, speed rating, treadwear, traction, temperature ratings, uniform tire quality grading (UTQG), safety warnings, safety instructions, manufacturer information, regulatory compliance information, and/or barcodes or quick response (QR) codes.

Manufactures or retailers custom print or image the information on the frontside of the tire labels using printers and application software based on their needs and requirements. Because the tire labels must stick to an uneven rubber tire surface, the backside of the labels require a high tack adhesive. Manufacturing a roll of tire labels is challenging because the high tack adhesive when cut by a printer quickly causes adhesive buildup within the printer and printer malfunction. Consequently, conventional rolls of tire labels are manufactured with a liner such that the printer cuts the liner attached to the backside of the label to minimize adhesive buildup within the printer.

Using two substrates for the label, the label substrate and the liner substrate, creates unnecessary waste, which must be discarded, and may end up in landfills as unrecycled waste. Also, the liner substrate must be manually separated from the label substrate before the tire label can be applied to a tire. Furthermore, because two substrates are used fewer labels can be placed in a roll since the roll has to be able to fit within a printer and because the liner substrate increases the size and weight of the roll

### BRIEF DESCRIPTION OF THE DRAWINGS

FIG. 1 is a diagram of a backside of a linerless tire label, according to an example embodiment.

FIG. 2 is a diagram of a frontside of a linerless tire label, according to an example embodiment.

FIG. 3 is a diagram of a roll of linerless tire labels illustrating a backside of the roll, according to an example embodiment.

FIG. 4 is a diagram of a roll of linerless tire labels illustrating a frontside of the roll, according to an example embodiment.

FIG. 5 is a diagram of a method of manufacturing a roll of linerless tire labels, according to an example embodiment.

### DETAILED DESCRIPTION

As stated above, conventional rolls of tire labels require two substrates. One label substrate for the tire labels themselves and one liner substrate affixed to the backside of the label substrate. The conventional roll is then fed through a printer and imaged with custom indicia and cut into individual tire labels. This minimizes adhesive buildup within the printer but also requires manual separation of the liner from the label before the label is applied to a tire. This also generates unnecessary waste associated with the liner, which can end up in landfills and is not environmentally friendly.

The teachings herein provide a linerless tire label and a roll of linerless tire labels. A high-tack adhesive, for example hotmelt rubber adhesive, is deposed as a patch on a backside of a label substrate. The patches within the roll are separated by oversized sense marks. The sense marks provide instructions to the printer to cut individual tire labels from the roll through a substantial center of the sense marks. In this way, there is no adhesive buildup within the printer while the roll and labels are linerless requiring only a label substrate for the tire labels of the roll. Furthermore, each adhesive patch is offset from the edges of the label substrate such that there is a gap of adhesive-free area surrounding the patch of a given tire label within the roll. A frontside of the label substrate is coated with a release coating, such as a silicone-based release coating, ensuring that the backside of the label substrate when unwound from the roll by a printer releases from and does not stick to the frontside of the label substrate.

As a result, the teachings are environmentally friendly by reducing waste since there is only a single label substrate associated with the roll while at the same time the teachings eliminate manual steps associated with removing a liner and discarding the liner as waste. Additionally, the teachings eliminate or substantially minimize adhesive buildup on components of the printer. Furthermore, the rolls of the linerless tire labels are weighing significantly less and are of smaller size because they lack a liner substrate. As a result, the roll of linerless tire labels provided herein permit more labels per roll than conventional liner-based tire label rolls; the rolls of linerless tire labels provided herein also permit shipping by truck and reduce shipping expense.

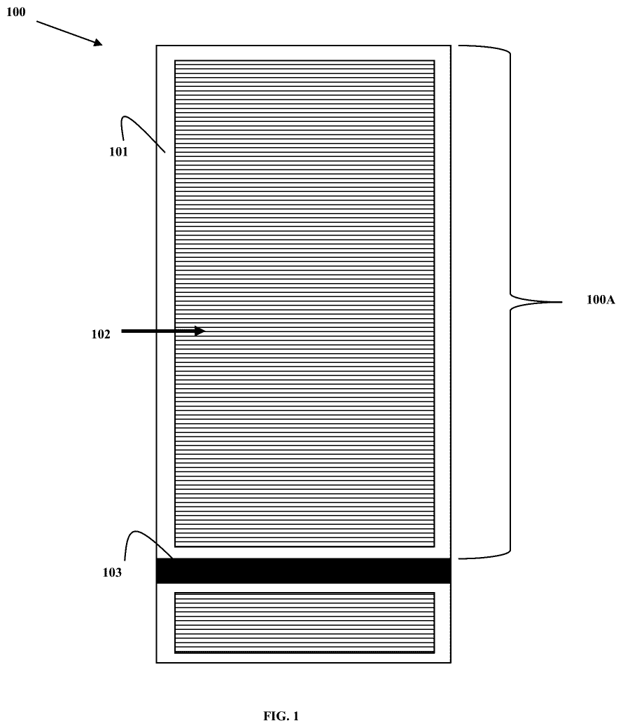

FIG. 1 is a diagram of a backside 100A of a linerless tire label 100, according to an example embodiment. Notably, components of the linerless tire label 100, as shown in FIG. 1, is simplified to illustrate just those components necessary for comprehending the teachings presented herein. Other components or arrangement of components can be used without departing from the beneficial teachings presented herein.

A linerless tire label 100 is depicted in FIG. 1. The backside 100A of the linerless tire label 100 is shown as well as a portion of a next linerless tire label 100 of a roll. The linerless tire label 100 includes gaps 101 of adhesive-free area that surrounds the peripheral sides of the linerless tire label. An adhesive path 102 is deposited on the backside 100A and is surrounded by and substantially centered inside of the gaps 101. Adjacent to a bottom gap 101 is an oversized printed sense mark 103. Below the sense mark 103 is a start of a next linerless tire label 100 of the roll.

The gaps 101 of adhesive-free areas are continuous and connected along an outer periphery of the backside 100A. The adhesive patch 102 is substantially centered on the backside 100A adjacent to the gaps 101. Each gap 101 corresponds to an outer side of the backside 100A and each gap 101 extending from a corresponding outer side of the backside 100A and abutting a corresponding side of the adhesive patch 102.

In an embodiment, the gaps 101 are offset or have a width of approximately 2 mm. In an embodiment, the oversized sense mark 103 extends the width of the linerless tire label 100 and is approximately 5 mm in width. This is different than conventional sense marks, which are smaller in width, and which do not extend across the entire width of a conventional label. The oversized width of the sense mark 103 combined with gaps 101 of adhesive-free areas on either side of the sense mark between pairs of linerless tire labels 100 on the roll provide sufficient error margin that ensures a printer cuts an individual linerless tire label 100 from the roll without encounter any adhesive.

In an embodiment, the adhesive patch 102 is a hotmelt rubber adhesive patch. In an embodiment, the hotmelt rubber adhesive patch is discontinuously disposed on the backside 100A of the linerless tire label 100, such that there are areas within the adhesive patch 102, which do not overlap or intersect. In an embodiment, the adhesive patch 102 is disposed on the backside 100A of the linerless tire label 100 in non-intersecting rows and/or patterns of discontinuous hotmelt rubber adhesive. In an embodiment, that adhesive patch 102 is disposed on the backside 100A of the linerless tire label 100 as a single continuous adhesive patch.

In an embodiment the adhesive patch 102 includes a solvent-acrylic or emulsion-acrylic adhesive. In an embodiment, the adhesive patch 102 includes a ultraviolet (UV) acrylic hotmelt adhesive. In an embodiment, the adhesive patch 102 includes a UV-curable adhesive. In an embodiment, the adhesive patch includes a light emitting diode (LED)-curable adhesive. In an embodiment, the adhesive patch 102 includes an acrylic hotmelt adhesive. In an embodiment, the adhesive of the adhesive patch 102 is any adhesive or adhesive mixture with a sufficient tack or adhesive bond to stick to uneven rubber-based tires.

In an embodiment, a silicone-based release coating is disposed on the frontside surface of the linerless tire label 100 such that when the roll of linerless tire labels 100 is wound into a roll, the silicone-based release coating is between the frontside of the linerless tire labels 100 of the roll and the backside 100A that includes the adhesive patches 102 for the linerless tire labels 100 of the roll. In an embodiment, the release coating is a non-silicone based release coating or a mixture of silicone and non-silicone based release coatings.

In an embodiment, the frontside of the linerless tire labels 100 include a thermally activated print or image coating activated by a thermal print head(s) of a thermal printer to print or image custom indicia on the frontside of the linerless tire labels 100. In an embodiment, a silicone-based release coating is disposed over and on top of the thermally activated print or image coating on the frontside of the linerless tire labels 100.

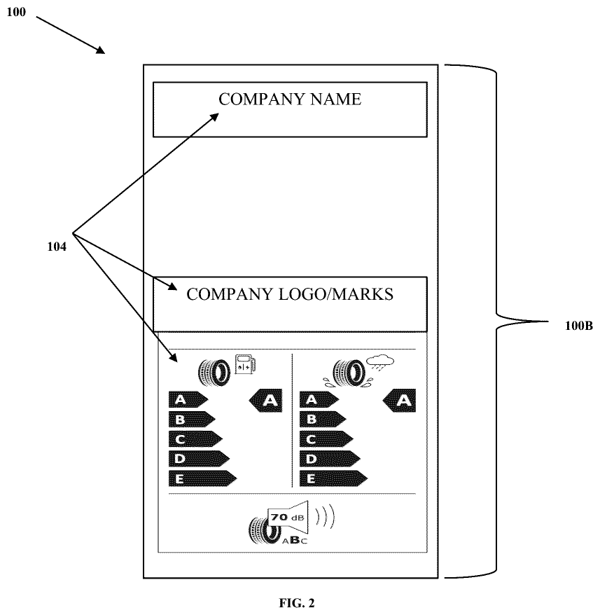

FIG. 2 is a diagram of a frontside 100B of a linerless tire label 100, according to an example embodiment. Again, and notably, components of the linerless tire label 100, as shown in FIG. 2, is simplified to illustrate just those components necessary for comprehending the teachings presented herein. Other components or arrangement of components can be used without departing from the beneficial teachings presented herein.

The frontside 100B of the linerless tire label 100 includes a print coating, such as a thermally activated print or image coating, a dot matrix print coating, a laser print coating, a dot matrix print coating, a thermal transfer ribbon applied, or an inkjet print coating. FIG. 2 illustrates a linerless tire label 100 after the print coating has been printed or imaged with example custom indicia 104 by a printer. In the example provided, the custom indicia 104 includes a company name, company logos and/or marks, and regulatory required and/or company required information printed or imaged as a combination of text, graphics, and images on the frontside 100B of the linerless tire label 100.

Again, and in an embodiment, a silicone-based release coating is disposed over the print coating. This ensures when a roll of the linerless tire labels 100 is wound into a roll, the release coating is sandwiched between the print coating on the frontside 100B and the adhesive patch 102 on the backside 100A.

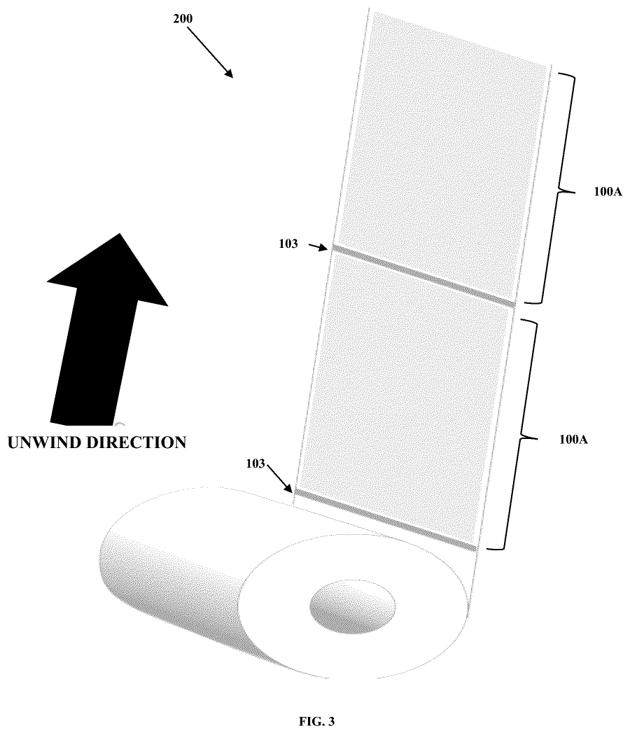

FIG. 3 is a diagram of a roll 200 of linerless tire labels 100 illustrating a backside 100A of the roll 200, according to an example embodiment. Notably, components of the roll 200, as shown in FIG. 3, is simplified to illustrate just those components necessary for comprehending the teachings presented herein. Other components or arrangement of components can be used without departing from the beneficial teachings presented herein.

The roll 200 includes a single label substrate, which is wound into the roll 200 for insertion into a printer. The printer unwinds the roll 200 and based on software instruction prints or images custom indicia 104 on the frontside 100B and cuts an individual linerless tire label 100 from the roll 200. The printer cuts each linerless tire label 100 from the roll 200 along a corresponding printed oversized sense mark 103, which is adjacent on either side adhesive-free gaps 101, ensuring that adhesive buildup on components of the printer are minimized or eliminated. The printer unwinds the roll 200 in an unwind direction as illustrated in FIG. 3. It is noted that the unwind direction as illustrated is an example as the unwind direction can be in an opposite direction from what is illustrated in FIG. 3.

Each side of each adhesive patch 102 is adjacent to a gap 101 associated with an adhesive-free area along the backside 100A. The sense marks 103 are printed or imaged on the backside 100A. Each sense mark 103 extending across a width of the backside 100A and situated under a corresponding gap 101 for a corresponding adhesive patch 102 and above a next corresponding gap 101 for a next corresponding adhesive patch 102. Each sense mark 103 delineates two linerless tire labels 100 with the roll 200 of linerless tire labels 100.

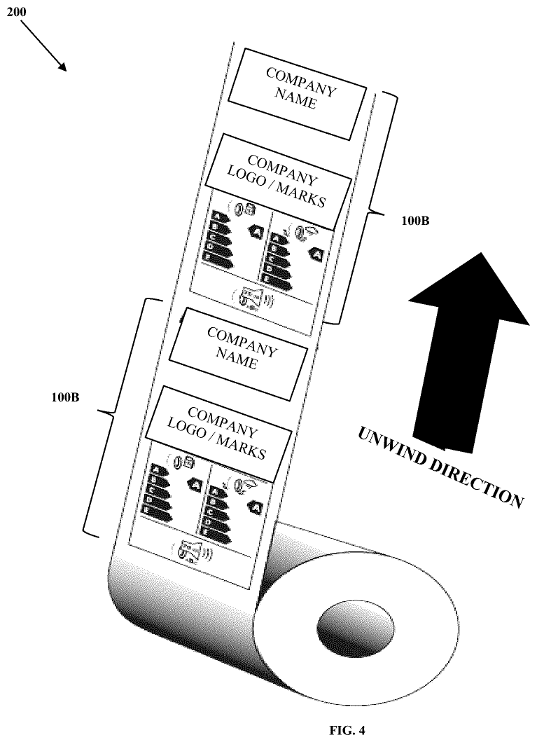

FIG. 4 is a diagram of a roll 200 of linerless tire labels 100 illustrating a frontside 100B of the roll 200, according to an example embodiment. Notably, components of the roll 200, as shown in FIG. 4, is simplified to illustrate just those components necessary for comprehending the teachings presented herein. Other components or arrangement of components can be used without departing from the beneficial teachings presented herein. Other components, by way of example only, can include coatings such as release, print, primer coatings, and/or perforations applied to or made in the single liner substrate of the roll 200 to define additional removable labels from a single individual linerless tire label 100.

FIG. 4 illustrates the frontside 100B of the single label substrate for the roll 200 after a few of the linerless tire labels 100 have been printed to or imaged by a printer with custom indicia 104. Again, the custom indicia 104 is printed or imaged by the printer based on software instructions and based on regulatory and/or company requirements for tire label information. The custom indicia 104 can include text, graphics, images, etc. Again, the roll 200 is unwound by a printer in the direction illustrated in FIG. 4 after the roll 200 is loaded within the printer for custom printing and/or imaging. Again, the direction in which the roll 200 is unwound as illustrated is presented as an example and the unwinding direction can be the opposite of what is illustrated in FIG. 4.

In an embodiment, a release coating is disposed on the frontside 100B. In an embodiment, the release coating is disposed over top of a print coating that is on the frontside 100B. In an embodiment, the print coating is a thermally activated print coating, a laser print coating, a dot matrix print coating, thermal transfer ribbon applied, or an injet print coating. In an embodiment, the release coating is a silicone release coating and adhesive associated with the adhesive patches 102 is a hotmelt rubber adhesive.

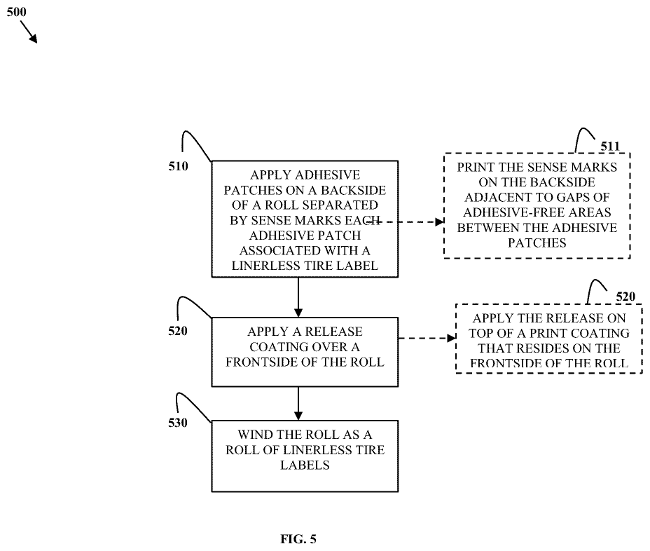

FIG. 5 is a diagram of a method 500 of manufacturing a roll 200 of linerless tire labels 100, according to an example embodiment. The method is performed by a press. The electromechanical components of the press are controlled by executable instructions. The executable instructions are executed by a processor to perform the operations of the method 500 by controlling stations of the press and their electromechanical components. Example stations include, by way of example only, a release coating application station, an adhesive coating application station, a primer coating station, a winding station, an unwinding station, one or more coating drying stations, a sense mark printing station, etc.

At 510, the press applies or deposits adhesive patches 102 on a backside 100A of a single label substrate for a roll 200 of linerless tire labels 100. Each adhesive patch 102 is separated by an oversized sense mark 103 and each adhesive patch 102 associated with a linerless tire label 100. In an embodiment, at 511, the press prints oversized sense marks 103 on the backside 100A adjacent to gaps 101 of adhesive-free areas between the adhesive patches 102 associated with the linerless tire labels 100 on the roll 200. In an embodiment, the gaps 101 of adhesive-free areas are approximately 2 mm wide. In an embodiment, the sense marks 103 are approximately 5 mm wide and extend across the entire width of the single label substrate.

At 520, the press applies or deposits a release coating over a frontside 100B of the single label substrate for the roll 200. In an embodiment, at 521, the press applies or deposits the release coating on top of a print coating that resides on the frontside 100B of the single label substrate for the roll 200.

At 530, the press winds the roll 200 as a roll 200 of linerless tire labels 100. The roll 200 is significantly smaller in size and weight than a conventional liner-based roll of tire labels. The roll 200 also includes no liner waste, requires no manual removal of an extra liner during label application, and reduces or eliminates adhesive printer buildup because the printer's cutting mechanism is instructed to cut along the oversized sense marks 103 of the roll 200 and their location adjacent to gaps 101 of adhesive-free areas along the roll 200. Thus, the roll 200 includes more linerless tire labels 100 than a conventional liner-based roll of tire labels and the roll 200 is also less expensive to ship and easy to transport.

Although the present invention is described with particular reference to certain preferred embodiments thereof, variations and modifications of the present invention can be affected within the spirit and scope of the following claims.

1. A linerless tire label, comprising:
a substrate; and
an adhesive patch disposed on a backside of the substrate and surrounded by gaps of adhesive-free areas, wherein the gaps of adhesive-free areas are adjacent to sides of the backside.

2. The linerless tire of claim 1 further comprising:
a release coating disposed on a frontside of the substrate.

3. The linerless tire of claim 2, wherein the release coating is disposed over a print coating that is on the frontside of the substrate.

4. The linerless tire of claim 3, wherein the print coating is one of a thermally activated print coating, a laser print coating, dot matrix print coating, or inkjet coating.

5. The linerless tire of claim 4, wherein the release coating is a silicone-based release coating.

6. The linerless tire of claim 1, wherein adhesive patch comprises hotmelt rubber adhesive, solvent-acrylic adhesive, or emulsion-acrylic adhesive.

7. The linerless tire of claim 1, wherein adhesive of the adhesive patch is discontinuous within the adhesive patch.

8. The linerless tire of claim 7, wherein the discontinuous adhesive is arranged within the adhesive patch in a pattern.

9. The linerless tire of claim 1, wherein the gaps of the adhesive-free areas are continuous and connected along a periphery of the backside.

10. The linerless tire of claim 9, wherein the adhesive patch is substantially centered on the backside adjacent to the gaps.

11. The linerless tire of claim 1, wherein each gap corresponds to an outer side of the backside.

12. The linerless tire of claim 1, wherein each gap is approximate 2 mm wide extending from a corresponding outer side and abutting a corresponding side of the adhesive patch.

13. A roll of linerless tire labels, comprising:
a substrate;
adhesive patches disposed on a backside of the substrate; each side of each adhesive patch adjacent to a gap associated with an adhesive-free area along the backside; and
sense marks printed or imaged on the backside, each sense mark extending across a width of the backside and situated under a corresponding gap for a corresponding adhesive patch and above a next corresponding gap for a next corresponding adhesive patch;
wherein each sense mark delineates two linerless tire labels defined within the roll of linerless tire labels.

14. The roll of linerless tire labels of claim 13 further comprising:
a release coating disposed on a frontside of the substrate.

15. The roll of linerless tire labels of claim 14, wherein release coating is disposed over top of a print coating that is on the frontside.

16. The roll of linerless tire labels of claim 15, wherein release coating is a silicone release coating and adhesive associated with the adhesive patches is a hotmelt rubber adhesive.

17. The roll of linerless tire labels of claim 13, wherein each sense mark is approximately 5 mm in width.

18. A method comprising:
applying, by a press, adhesive patches on a backside of a roll separated by sense marks, each adhesive patch associated with a linerless tire label;
applying, by the press, a release coating over a frontside of the roll; and
winding the roll as a roll of linerless tire labels.

19. The method of claim 18, wherein applying the adhesive patches further includes printing the sense marks on the backside adjacent to adhesive-free areas between the adhesive patches.

20. The method of claim 18, wherein applying the release coating further includes winding the roll as a roll of linerless tire labels.
